(19) United States
(12) Patent Application Publication
(10) Pub. No.: US 2011/0090421 A1
(43) Pub. Date: Apr. 21, 2011

(54) Light Emitting Device and Display Device with the Same as Light Source

(75) Inventor: Duck-Gu Cho, Yongin-si (KR)

(73) Assignee: SAMSUNG SDI CO., LTD., Yongin-si (KR)

(21) Appl. No.: 12/877,610

(22) Filed: Sep. 8, 2010

(30) Foreign Application Priority Data
Oct. 15, 2009 (KR) 10-2009-0098343

(51) Int. Cl. G02F 1/1335; H01J 1/62

(52) U.S. Cl. 349/61; 313/505

(57) ABSTRACT

A display device uses a light emitting device with heightened luminance at an outermost area thereof as a light source to enhance luminance uniformity of a display panel. The light emitting device includes cathode electrodes, gate electrodes insulated from the cathode electrodes by way of an insulating layer while proceeding in a direction crossing the cathode electrodes, and electron emission regions formed on the cathode electrodes at crossed zones of the cathode electrodes and the gate electrodes. The outermost cathode electrodes are each divided into at least two electrode portions including inner and outer cathode electrode portions, and the outermost gate electrodes are each divided into at least two electrode portions including inner and outer gate electrode portions. When the region of the outer cathode electrode portion and the outer gate electrode portion is called a first region, and the region of the inner cathode electrode portion and the inner gate electrode portion internal to the first region is called a second region, the first region is higher in electron emission intensity than the second region.

### CLAIM OF PRIORITY

This application makes reference to, incorporates the same herein, and claims all benefits accruing under 35 U.S.C.§119 from an application earlier filed in the Korean Intellectual Property Office on 15 Oct. 2009 and there duly assigned Serial No. 10-2009-0098343.

### BACKGROUND OF THE INVENTION

1. Field of the Invention

The present invention relates generally to a display device, and more particularly, to a light emitting device provided at the back side of a display panel so as to emit light to the display panel.

2. Description of the Related Art

A liquid crystal display (LCD) is known as a non-emissive display device that requires a light source. The liquid crystal display includes a display panel having pixels, electrodes interposing a liquid crystal layer therebetween, color filters, and polarizing plates, and a light source emitting light to the display panel. With the display panel, the display electrodes are driven so as to alter the alignment of liquid crystal molecules so as to control light transmittance of the respective pixels, thereby displaying a predetermined image.

A surface light emitting device has been recently developed as a light emitting device for replacing a cold cathode fluorescent lamp (CCFL) as a line light source and a light emitting diode (LED) as a point light source, in which electrons are emitted under the application of an electric field. With the surface light emitting device, electrons are emitted from the electron emission regions provided at a rear substrate so as to excite the phosphor layer formed on a front substrate, thereby emitting white light.

The above-identified light emitting device has low power consumption because the luminance loss due to a diffusion plate is small compared to the CCFL and the LED, and is advantageous for a large display device. However, with a display device using the light emitting device as a light source, the light emitted from the outermost area of the light emitting device is partially diffused and vanishes to the outside rather than being transmitted to the display panel so that the edge of the display panel may appear to be dark.

The above information disclosed in this Background section is only for enhancement of understanding of the background of the described technology, and therefore it may contain information that does not form the prior art that is already known in this country to a person of ordinary skill in the art.

### SUMMARY OF THE INVENTION

The present invention provides a display device using a light emitting device as a light source having increasing luminance at the outermost area thereof so as to enhance luminance uniformity of a display panel.

An exemplary embodiment of the invention provides a light emitting device including cathode electrodes, gate electrodes insulated from the cathode electrodes by way of an insulating layer while proceeding in a direction crossing the cathode electrodes, electron emission regions formed on the cathode electrodes at the crossed zones of the cathode electrodes with the gate electrodes, and a phosphor layer emitting visible light by way of the electrons emitted from the electron emission regions. The outermost cathode electrodes are each divided into at least two electrode portions including inner and outer cathode electrode portions, and the outermost gate electrodes are each divided into at least two electrode portions including inner and outer gate electrode portions. When the region of the outer cathode electrode portion and the outer gate electrode portion is called a first region, the region of the inner cathode electrode portion and the inner gate electrode portion internal to the first region is called a second region, and the region internal to the second region is called a third region. The first thru third regions vary in electron emission intensity from the highest to the lowest in a sequence of the first region, the second region, and the third region.

The cathode electrodes may be formed with the same width and the gate electrodes may be formed with the same width, and the outer cathode electrode portion and the outer gate electrode portion may be smaller in width than the inner cathode electrode portion and the inner gate electrode portion.

The electron emission regions arranged at the first to third regions may vary in density from the highest to the lowest in a sequence of the first region, the second region, and the third region. The electron emission regions may have the same size over the entire area of the first to third regions.

The gate electrodes and the insulating layer may have a plurality of openings for receiving the electron emission regions therein, and the insulating layer placed at the first to third regions may vary in thickness from the smallest to the largest in a sequence of the first region, the second region, and the third region. The electron emission regions may have the same size and density over the entire area of the first to third regions, and the plurality of openings have the same size.

An “on” pulse of the gate voltage inputted into the outer gate electrode portion may be larger in width than the “on” pulse of the gate voltage inputted into the inner gate electrode portion.

The maximum “on” pulse level of the gate voltage inputted into the outer gate electrode portion may be greater than the maximum “on” pulse level of the gate voltage inputted into the inner gate electrode portion.

The minimum “on” pulse level of the gate voltage inputted into the outer gate electrode portion may be smaller than the minimum “on” pulse level of the gate voltage inputted into the inner gate electrode portion.

The pulse width of the cathode voltage inputted into the outer cathode electrode portion during the period corresponding to the “on” pulse of the gate voltage inputted into the outer gate electrode portion may be smaller than the pulse width of the cathode voltage inputted into the inner cathode electrode portion during the period corresponding to the “on” pulse of the gate voltage inputted into the inner gate electrode portion.

The minimum pulse level of the cathode voltage inputted into the outer cathode electrode portion during the period corresponding to the “on” pulse of the gate voltage inputted into the outer gate electrode portion may be smaller than the minimum pulse level of the cathode voltage inputted into the inner cathode electrode portion during the period corresponding to the “on” pulse of the gate voltage inputted into the inner gate electrode portion.

The maximum pulse level of the cathode voltage inputted into the outer cathode electrode portion during the period corresponding to the “on” pulse of the gate voltage inputted into the outer gate electrode portion may be greater than the maximum pulse level of the cathode voltage inputted into the inner cathode electrode portion during the period corresponding to the “on” pulse of the gate voltage inputted into the inner gate electrode portion.

A display device according to an exemplary embodiment of the invention includes the above-identified light emitting device, and a display panel placed in front of the light emitting device to receive the light from the light emitting device and display images.

The display panel may have first pixels, and the light emitting device may have second pixels of a smaller number than the first pixels and emitting light corresponding to grayscales of the first pixels corresponding thereto. The display panel may be formed with a liquid crystal display panel.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partial sectional perspective view of a light emitting device according to a first exemplary embodiment of the invention.

FIG. 2 is a partial sectional view of the light emitting device shown in FIG. 1.

FIG. 3 is a schematic diagram of cathodes and gate electrodes in a light emitting device according to a first exemplary embodiment of the invention.

FIG. 4 is a schematic diagram of an effective area of a light emitting device according to a first exemplary embodiment of the invention.

FIG. 5 is a partial plan view of first to third regions of a light emitting device according to a first exemplary embodiment of the invention.

FIG. 6 is a partial sectional view of first to third regions of a light emitting device according to a second exemplary embodiment of the invention.

FIG. 7A and FIG. 7B illustrate waveforms of gate and cathode voltages according to a third exemplary embodiment of the invention.

FIG. 8A and FIG. 8B illustrate waveforms of gate and cathode voltages according to a fourth exemplary embodiment of the invention.

FIG. 9 is an exploded perspective view of a display device according to an exemplary embodiment of the invention.

FIG. 10 is a partial sectional view of a display panel in the display device shown in FIG. 9.

### DETAILED DESCRIPTION OF THE INVENTION

The present invention will now be described more fully with reference to the accompanying drawings, in which exemplary embodiments of the invention are shown.

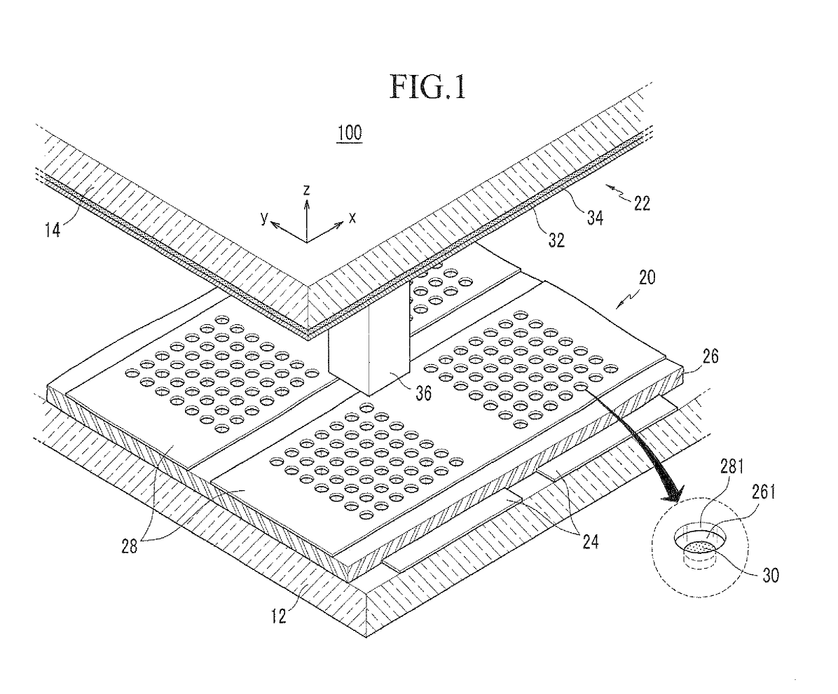

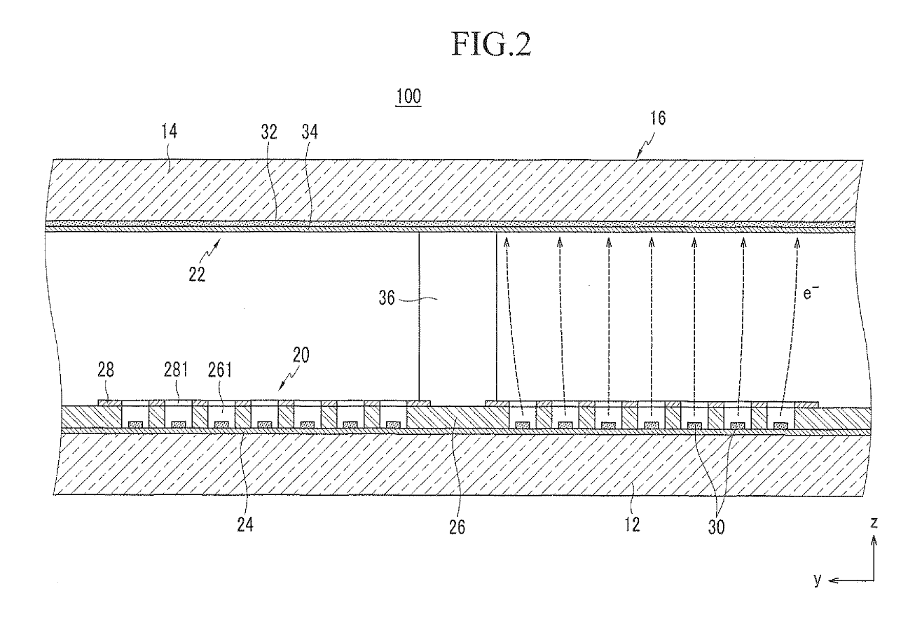

FIG. 1 is a partial cut-away perspective view of a light emitting device according to a first exemplary embodiment of the invention, and FIG. 2 is a partial sectional view of the light emitting device shown in FIG. 1.

Referring to FIG. 1 and FIG. 2, a light emitting device 100 according to a first exemplary embodiment of the invention includes first and second substrates 12 and 14, respectively, facing each other while spaced apart from each other by a predetermined distance. The first and second substrates 12 and 14, respectively, are sealed to each other at the edges thereof by way of a sealing member (not shown), and the interior thereof is evacuated to a vacuum degree of 10⁻⁶ Torr so as to construct a vacuum chamber 16 together with the sealing member.

An electron emitting unit 20 is provided on the inner surface of the first substrate 12 to emit electrons, and a light emitting unit 22 is provided on the inner surface of the second substrate 14 to emit visible light by way of the electrons.

The electron emitting unit 20 includes cathode electrodes 24 formed in a direction of the first substrate 12 (in the y axis direction of FIG. 2), gate electrodes 28 formed in a direction crossing the cathode electrodes 24 (in the x axis direction of FIG. 2) by interposing an insulating layer 26, and electron emission regions 30 formed on the cathode electrodes 24 at the crossed zones of the cathode electrodes 24 with the gate electrodes 28.

Openings 281 and 261 are formed at the gate electrode 28 and the insulating layer 26 at the crossed zone of the cathode electrode 24 and the gate electrode 28 such that they partially expose the surface of the cathode electrode 24, and electron emission regions 30 are formed on the cathode electrode 24 within the opening 261 of the insulating layer 26. The cathode electrode 24 supplies electric currents to the electron emission regions 30, and the gate electrode 28 forms an electric field around the electron emission regions 30 by way of the voltage difference thereof with the cathode electrode 24 so as to induce the emission of electrons.

Either one of the cathode electrode 24 and the gate electrode 28 mainly proceeding parallel to the row direction of the light emitting device 100 (in the x axis direction of FIG. 2), that is, the gate electrode 28 according to the first exemplary embodiment, receives the scan driving voltage so as to function as a scan electrode. The other electrode mainly proceeding parallel to the column direction of the light emitting device 100 (in the y axis direction of FIG. 2), that is, the cathode electrode 24 according to the first exemplary embodiment, receives the data driving voltage so as to function as a data electrode.

The electron emission regions 30 may be formed with a material, such as a carbonaceous material or a nanometer (nm) size material, emitting electrons by the application of an electric field under a vacuum atmosphere. For example, the electron emission regions 30 may contain a material selected from the group consisting of carbon nanotubes, graphite, graphite nanofiber, diamond-like carbon, fullerene C₆₀, silicon nanowire, and combinations thereof.

The light emitting unit 22 includes a phosphor layer 32 and an anode electrode 34 placed on a surface of the phosphor layer 32. The phosphor layer 32 may be a white phosphor layer, and is formed over the entire effective area of the second substrate 14. The anode electrode 34 may be a transparent conductive layer placed between the second substrate 14 and the phosphor layer 32, or a metallic thin film, such as an aluminum thin film, placed on the surface of the phosphor layer 32 directed toward the first substrate 12. FIG. 1 and FIG. 2 illustrate the second case.

The anode electrode 34 is an accelerating electrode for attracting the electron beams to the phosphor layer 32, and causes the phosphor layer 32 to be in a high potential state upon receipt of a high voltage. If the anode electrode 34 is formed with a metallic thin film, the anode electrode 34 reflects visible light emitted from the phosphor layer 32 to the first substrate 12 toward the second substrate 14 so as to increase the luminance of the light emitting device 100.

Spacers 36 are disposed between the first and the second substrates 12 and 14, respectively, so as endure the pressure applied to the vacuum chamber 16 and space the first and the second substrates 12 and 14, respectively, apart from each other by a predetermined distance. For convenience, FIG. 1 and FIG. 2 illustrate one spacer 36.

The light emitting device 100 includes a plurality of pixels with the combination of the cathode electrodes 24 and the gate electrodes 28. A predetermined driving voltage is applied to the cathode electrodes 24 and the gate electrodes 28 from the outside of the vacuum chamber 16, and a positive direct current voltage of several thousands of volts or more is applied to the anode electrode 34 so as to drive the plurality of pixels.

With the pixels, where the voltage difference between the cathode electrode 24 and the gate electrode 28 exceeds the threshold value, an electric field is formed around the electron emission regions 30 so that electrons are emitted from the electron emission regions 30. The emitted electrons are attracted by the anode voltage, and collide against the corresponding phosphor layer 32 so as to excite it and emit light. The light emission intensity of the phosphor layer 32 for the respective pixels corresponds to the amount of electrons emitted at the relevant pixel.

The light emitting device 100 according to the first exemplary embodiment of the invention increases the luminance at the outermost area so as to compensate for the light loss occurring at that outermost area. For this purpose, with the light emitting device 100 according to the first exemplary embodiment of the invention, the outermost cathode electrode and the outermost gate electrode are divided into at least two electrode portions, and the further from the inside the target region is, the greater electron emission intensity becomes so as to realize higher luminance.

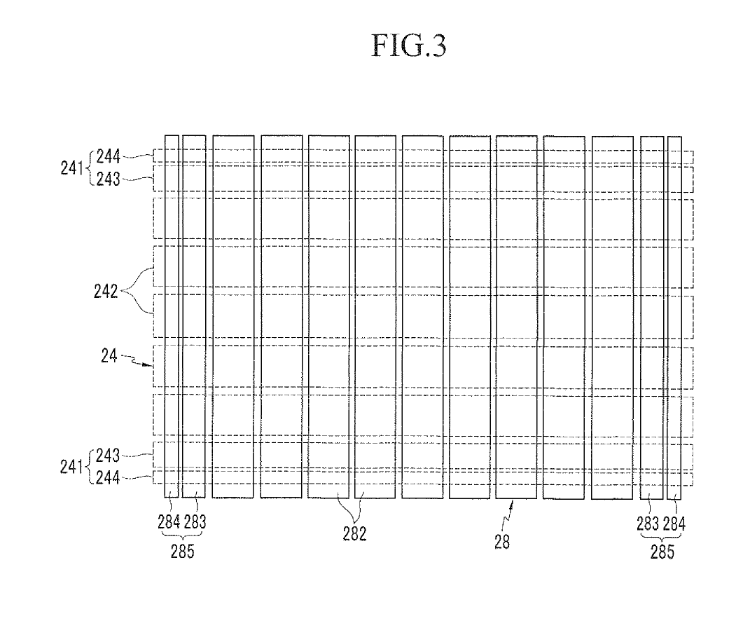

FIG. 3 is a schematic diagram of the cathode electrodes and the gate electrodes in the light emitting device according to the first exemplary embodiment of the invention.

Referring to FIG. 3, the cathode electrodes 24 include outermost cathode electrodes 241 (being the cathode electrodes placed at the upper and lower ends of FIG. 3), and central cathode electrodes 242 placed internal to the outermost cathode electrodes 241. The outermost cathode electrode 241 is divided into at least two electrode portions. FIG. 3 illustrates the case wherein the outermost cathode electrode 241 is divided into an inner cathode electrode portion 243 and an outer cathode electrode portion 244.

The gate electrodes 28 include outermost gate electrodes 285 (placed at the left and the right ends of FIG. 3), and central gate electrodes 282 placed internal to the outermost gate electrodes 285. The outermost gate electrode 285 is divided into at least two electrode portions. FIG. 3 illustrates the case wherein the outermost gate electrode 285 is divided into an inner gate electrode portion 283 and an outer gate electrode portion 284.

As shown in FIG. 3, the outermost cathode electrode 241 may have the same width as that of the central cathode electrode 242, and the outermost gate electrode 285 may have the same width as that of the central gate electrode 282. The outer cathode electrode portion 244 may have a smaller width than that of the inner cathode electrode portion 243, and the outer gate electrode portion 284 may have a smaller width than that of the inner gate electrode portion 283.

With the above-described light emitting device 100, the electron emitting unit 20 has an effective area where the cathode electrodes 24 and the gate electrodes 28 cross each other, and the electron emission regions 30 are formed so as to practically emit electrons.

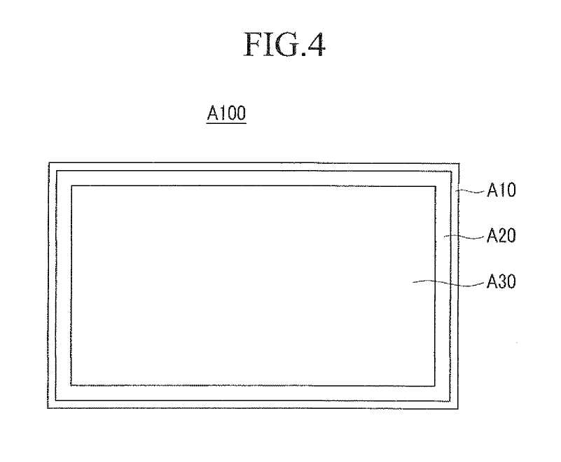

FIG. 4 is a schematic diagram illustrating the effective area of the light emitting device according to the first exemplary embodiment of the invention.

Referring to FIG. 4, the effective area A100 includes a first region A10 provided with the outer cathode electrode portion 244 and the outer gate electrode portion 284, a second region A20 formed internal to the first region A10 with the inner cathode electrode portion 243 and the inner gate electrode portion 283, and a third region A30 formed internal to the second region A20.

Referring to FIG. 3 and FIG. 4, the first region A10 includes the crossed zones of the outer cathode electrode portions 244 with all of the gate electrodes 28 and the crossed zones of the outer gate electrode portions 284 with all of the cathode electrodes 24.

The second region A20 includes the crossed zones of the inner cathode electrode portions 243 with the gate electrodes 28 including the inner gate electrode portions 283 and the central gate electrodes 282 except for the outer gate electrode portions 284, and the crossed zones of the inner gate electrode portions 283 with the cathode electrodes 24 including the inner cathode electrode portions 243 and the central cathode electrodes 242 except for the outer cathode electrode portions 244.

The third region A30 includes the crossed zones of the central cathode electrodes 242 with the central gate electrodes 282.

With the above-described light emitting device 100, the second region A20 is higher in electron emission intensity than the third region A30 so as to realize higher luminance compared with the third region A30. Furthermore, the first region A10 is higher in electron emission intensity than the second region A20 so as to realize higher luminance compared with the second region A20. For this purpose, with the light emitting device 100 according to the first exemplary embodiment of the invention, the electron emission regions 30 arranged at the first to third regions A10, A20, and A30 differ in density from each other.

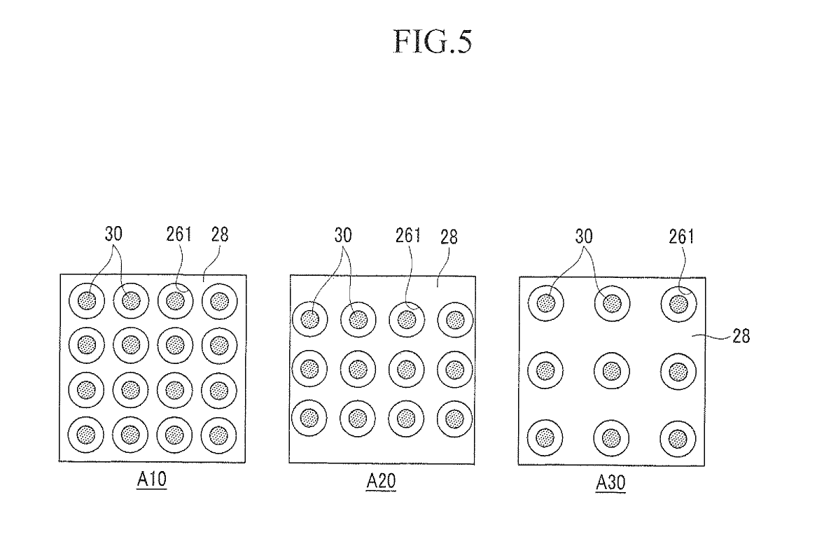

FIG. 5 is a partial plan view of the first to third regions with the same unit area in the light emitting device according to the first exemplary embodiment of the invention.

Referring to FIG. 5, the electron emission regions 30 placed at the first region A10 are higher in density than the electron emission regions 30 placed at the second region A20, and the electron emission regions 30 placed at the second region A20 are higher in density than the electron emission regions 30 placed at the third region A30.

Throughout the entire effective area A100, the electron emission regions 30 have the same size, and the insulating layer openings 261 also have the same size. With the same unit area, the electron emission regions 30 arranged at the first to third regions A10, A20, and A30 differ in number from each other such that the number thereof becomes larger in a sequence of the first region A10, the second region A20, and the third region A30.

Accordingly, under the same voltage condition, the light emitting device 100 varies in electron emission intensity from the highest to the lowest in a sequence of the first region A10, the second region A20, and the third region A30. Consequently, the light emitting device 100 may realize higher luminance at the outermost area with the first and second regions A10 and A20 corresponding to the outermost cathode electrodes 241 and the outermost gate electrodes 285, compared with the third region A30. The light emitting device 100 compensates for the amount of loss of the light emitted from the outermost area and diffused and vanished to the outside so that the problem of the edge of the display panel appearing to be dark can be solved.

Furthermore, as the luminance of the second region A20 in the outermost area is lower than the luminance of the first region A10, the luminance variation in the first and third regions A10 and A30 can be induced to be slow. Accordingly, when the light emitting device 100 is used as a light source for a display device, the luminance uniformity of a display panel can be enhanced over the entire effective area A100.

The first region A10 may realize luminance two times higher than that of the third region A30. In the case wherein the outer cathode electrode portion 244 and the outer gate electrode portion 284 are each formed with a smaller width than that of the inner cathode electrode portion 243 and the inner gate electrode portion 283, the luminance difference between the first and second regions A10 and A20 observed thorough the display panel screen can be reduced more effectively.

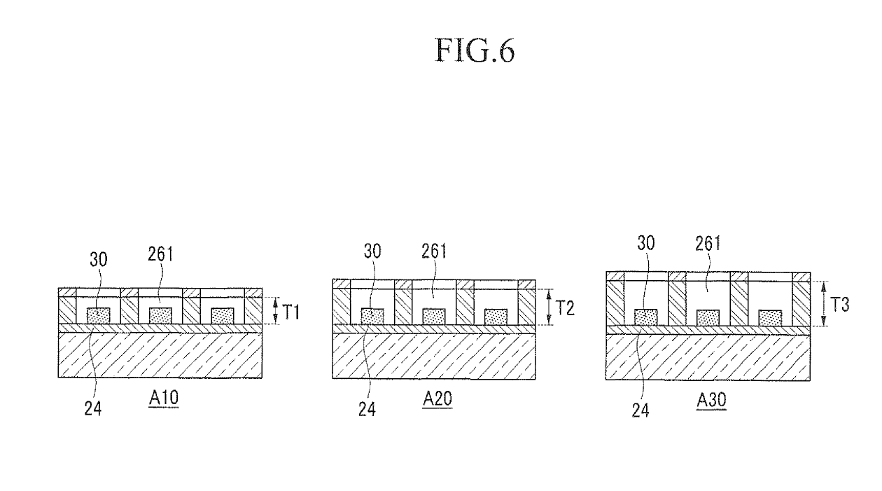

FIG. 6 is a partial sectional view of first to third regions in a light emitting device according to a second exemplary embodiment of the invention.

Referring to FIG. 6, the insulating layer 26 is placed at the first region A10 with a first thickness T1, the insulating layer 26 is placed at the second region A20 with a second thickness T2, and the insulating layer 26 is placed at the third region A30 with a third thickness T3. The first thickness T1 is smaller than the second thickness T2, which is in turn smaller than the third thickness T3. The density and size of the electron emission regions 30 and the size of the insulating layer opening 261 are established to be the same over the entire effective area A100.

The smaller that the thickness of the insulation layer 26 is, the more the distance between the electron emission regions 30 and the gate electrode 28 is reduced so that the electron emission intensity becomes higher with respect to the same driving voltage. Accordingly, under the same driving voltage condition, the light emitting device 100 according to the second exemplary embodiment of the invention varies in electron emission intensity from the highest to the lowest in a sequence of the first region A10, the second region A20, and the third region A30, and as a result, exerts the same effects as with the light emitting device according to the first exemplary embodiment of the invention.

It is described above, in relation to the first and second exemplary embodiments of the invention, that the density of the electron emission regions 30 and the thickness of the insulating layer 26 are altered so as to control the electron emission intensity of the first to third regions A10 to A30. However, the present embodiment of the invention is not limited to the above-described arrangement, and the gate and cathode voltages applied to the gate electrodes 28 and the cathode electrodes 24 corresponding to the first to third regions A10 to A30, respectively, may be altered to control the electron emission intensity.

First, the gate voltages applied to the first to third regions A10 to A30 may differ in “on” pulse size or width from each other. By contrast, the cathode voltages applied to the first to third regions A10 to A30 may differ in pulse size or width from each other with respect to the same gate voltage “on” pulse.

The gate voltage “on” pulse refers to the pulse for controlling the “on” period of time when electrons are emitted from the electron emission regions, and with third and fourth exemplary embodiments of the invention, the “on” pulse has a high level. The “on” period is controlled in accordance with the cathode voltage pulse as a function of the grayscales during the gate voltage “on” pulse period. When the cathode voltage pulse, which is kept at a low level during the gate voltage “on” pulse period, is shifted to a high level, the electrons are not emitted from the electron emission regions. The electron emission regions emit electrons at an intensity corresponding to the difference between the low level of the cathode voltage pulse and the “on” pulse level of the gate voltage (referred to hereinafter as the gate-cathode voltage).

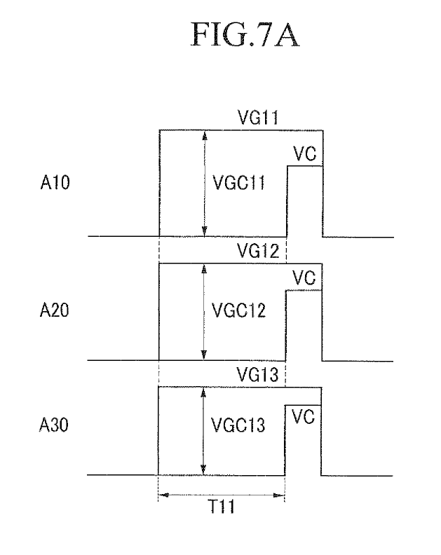

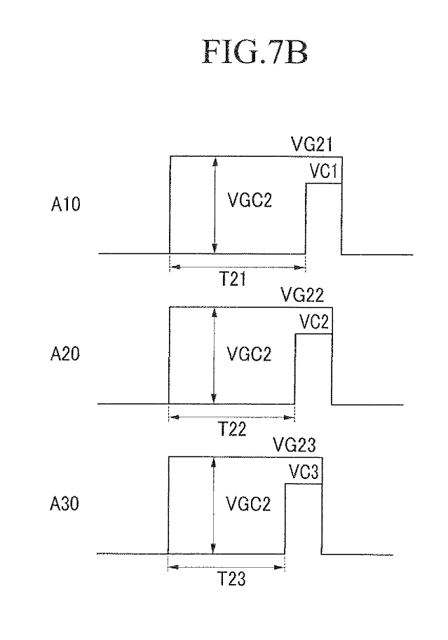

FIG. 7A and FIG. 7B illustrate waveforms of gate and cathode voltages according to a third exemplary embodiment of the invention.

FIG. 7A illustrates the case wherein the gate voltages VG11 to VG13 corresponding to the first to third regions A10 to A30, respectively, differ in “on” pulse size from each other. Specifically, it is illustrated that the gate voltages VG11 to VG13 during the light emitting period T11 differ in the maximum “on” pulse voltage from each other.

The maximum “on” pulse value of the gate voltage is reduced from the highest to the lowest in a sequence of the gate voltage VG11 corresponding to the first region A10, the gate voltage V12 corresponding to the second region A20, and the gate voltage VG13 corresponding to the third region A30. Then, the gate-cathode voltage VGC11 of the first region A10 is the highest, the gate-cathode voltage VGC12 of the second region A20 next to the gate-cathode voltage VGC11 of the first region A10 is lower, and the gate-cathode voltage VGC13 of the third region A30 is the lowest.

Accordingly, the first to third regions A10, A20, and A30 differ in luminance from each other with respect to the same cathode voltage such that the luminance thereof varies from the highest to the lowest in a sequence of the first region A10, the second region A20, and the third region A30. The “on” pulse size of the respective gate voltages VG11, VG12, and VG13 can be appropriately established to be so large as to compensate for the luminance deviation per the respective locations of the first to third regions A10 to A30.

FIG. 7B illustrates the case wherein the gate voltages corresponding to the first to third regions A10 to A30 respectively differ in “on” pulse width from each other.

The gate voltage “on” pulse width is reduced from the largest to the smallest in a sequence of the gate voltage VG21 corresponding to the first region A10, the gate voltage VG22 corresponding to the second region A20, and the gate voltage VG23 corresponding to the third region A30. Then, the first period of time T21 when the first region A10 emits light by way of the gate-cathode voltage VGC2 is the longest, the second time period T22 when the second region A20 emits light next to the first time period T21 is less, and the third time period T23 when the third region A30 emits light is the shortest.

Accordingly, the first to third regions A10, A20, and A30 differ in luminance from each other with respect to the same cathode voltage such that the luminance thereof varies from the highest to the lowest in a sequence of the first region A10, the second region A20, and the third region A30. The pulse width of the first to third gate voltages VG21, VG22, and VG23 is appropriately established to be so large as to compensate for the luminance deviation per the respective locations of the first to third regions A10 to A30.

The gate and cathode voltages with respect to the same grayscale are now described in relation to the third exemplary embodiment of the invention. The grayscale indicates the dimension of luminance as a function of the emission of light from the phosphor layer, and conventionally, the gate and cathode voltages with respect to the same grayscale are the same irrespective of the regions of the light emitting device. With the third exemplary embodiment of the invention, the luminance deviation as a function of the different regions is compensated for by differently controlling the size and width of the gate voltage “on” pulse with respect to the same grayscale at the respective first to third regions.

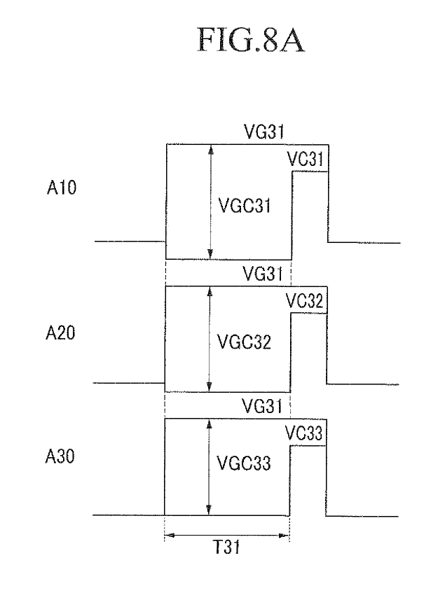

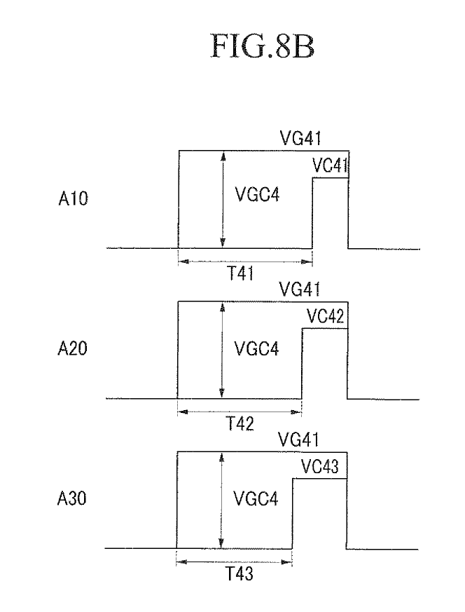

FIG. 8A and FIG. 8B illustrate the waveforms of gate and cathode voltages according to a fourth exemplary embodiment of the invention.

FIG. 8A illustrates the case wherein the cathode voltages VC31 to VC33 corresponding to the first to third regions A10 to A30 respectively differ in pulse size from each other, specifically, that the cathode voltages VC31 to VC33 during the light emission period T31 differ in the minimum pulse voltage from each other.

The cathode voltages VC31 to VC33 increase in the minimum pulse voltage from the lowest to the highest in a sequence of the cathode voltage VC31 corresponding to the first region A10, the cathode voltage VC32 corresponding to the second region A20, and the cathode voltage VC33 corresponding to the third region A30. Then, the gate-cathode voltage VGC31 of the first region A10 is the highest, the gate-cathode voltage VGC32 of the second region A20 next to the gate-cathode voltage VCG31 of the first region A10 is lower, and the gate-cathode voltage VGC33 of the third region A30 is the lowest.

Accordingly, the first to third regions A10 to A30 differ in luminance from each other with respect to the same gate voltage such that the luminance thereof varies from the highest to the lowest in a sequence of the first region A10, the second region A20, and the third region A30. The dimension of the minimum pulse voltage of the first to third cathode voltages VC31, VC32, and VC33 is appropriately established so as to be large enough to compensate for the luminance deviation as a function of the locations of the first to third regions A10 to A30.

FIG. 8B illustrates the case wherein the cathode voltages VC41 to VC43 corresponding to the first to third regions A10 to A30 respectively differ in pulse width from each other.

The cathode voltages are enlarged in pulse width from the smallest to the largest in a sequence of the cathode voltage VC41 corresponding to the first region A10, the cathode voltage VC42 corresponding to the second region A20, and the cathode voltage VC43 corresponding to the third region A30. Then, the first time period T41 when the first region A10 emits light by way of the gate-cathode voltage VGC4 is the longest, the second time period T42 when the second region A20 emits light next to the first time period T41 is shorter, and the third time period T43 when the third region A30 emits light is the shortest.

Accordingly, the first to third regions A10 to A30 differ in luminance from each other with respect to the same gate voltage such that the luminance thereof varies from the highest to the lowest in a sequence of the first to third regions A10, A20, and A30. The pulse width of the first to third cathode voltages VC41, VC42, and VC43 is appropriately established so as to be large enough to compensate for the luminance deviation as a function of the locations of the first to third regions A10 to A30.

The gate and cathode voltages with respect to the same grayscale are described in relation to the fourth exemplary embodiment of the invention as with the third exemplary embodiment of the invention. With the fourth exemplary embodiment of the invention, the size and width of the cathode voltage pulse with respect to the same grayscale are differently controlled in the respective first to third regions so as to compensate for the luminance deviation as a function of the different regions.

It is illustrated in relation to the third and fourth exemplary embodiments of the invention that the gate voltage “on” pulse is in a high level, but the phase may be reversed. That is, it is possible that the “on” pulse of the gate voltage is at a low level but the gate voltage is at a high level during the period except for the “on” period. In this case, the pulse of the cathode voltage is at a high level during the period pursuant to the grayscale of the “on” period, and the electron emission regions emit electrons during the period when the pulse of the cathode voltage is at a high level.

When applied to the third exemplary embodiment of the invention, the “on” pulse of the gate voltage in the first region is the lowest, the “on” pulse of the gate voltage in the second region next thereto is higher, and the “on” pulse of the gate voltage in the third region is the highest. In the case wherein the “on” pulse width of the gate voltage is controlled, as with the third exemplary embodiment of the invention, the “on” pulse of the gate voltage in the first region is the longest, the “on” pulse of the gate voltage in the second region next thereto is shorter, and the “on” pulse of the gate voltage in the third region is the shortest.

Furthermore, with the fourth exemplary embodiment of the invention, when the “on” pulse of the gate voltage is applied to the respective regions, the maximum pulse voltage of the cathode voltage in the first region is the highest, the maximum pulse voltage of the cathode voltage in the second region next thereto is lower, and the maximum pulse voltage of the cathode voltage in the third region is the lowest. When the “on” pulse of the gate voltage is applied to the respective regions, the pulse of the cathode voltage in the first region is the shortest, the “on” pulse of the cathode voltage in the second region next thereto is longer, and the pulse of the cathode voltage in the third region is the longest.

Meanwhile, it is described above that the outermost cathode electrodes 241 and the outermost gate electrodes 285 each are divided into two portions so as to partition the effective area A100 into three regions, but the outermost cathode electrodes 241 and the outermost gate electrodes 285 may be divided into three portions or more. In this case, the effective area A100 is partitioned into four regions or more, and the luminance becomes higher from the central region to the region further from the central region.

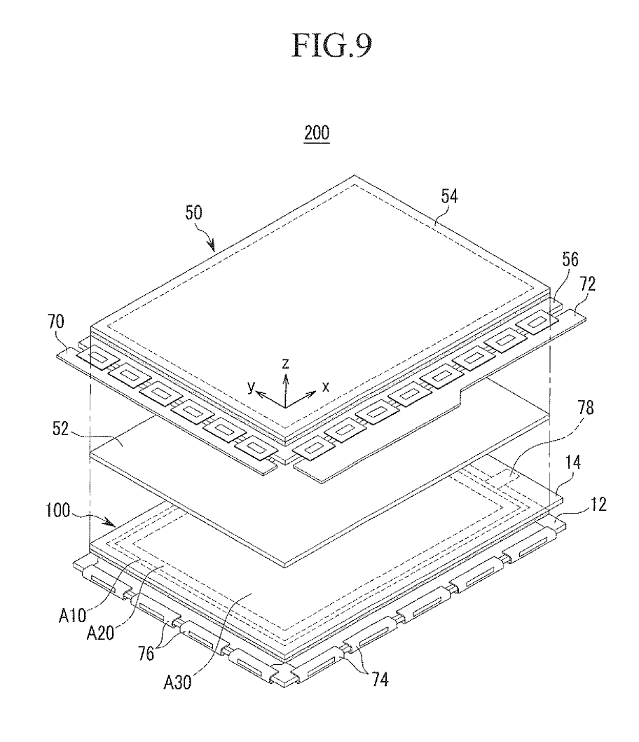

FIG. 9 is an exploded perspective view of a display device according to an exemplary embodiment of the invention.

Referring to FIG. 9, the display device 200 according to the present exemplary embodiment of the invention includes a light emitting device 100 according to any one of the first to fourth exemplary embodiments of the invention, and a display panel 50 placed in front of the light emitting device 100. The light emitting device 100 includes first to third regions A10, A20, and A30, which vary in luminance from the highest to the lowest in a sequence of the first region A10, the second region A20, and the third region A30.

A diffusion plate 52 is disposed between the light emitting device 100 and the display panel 50, and the light emitting device 100 and the diffusion plate 52 are spaced apart from each other by a predetermined distance. The display panel 50 may be formed as a liquid crystal display panel.

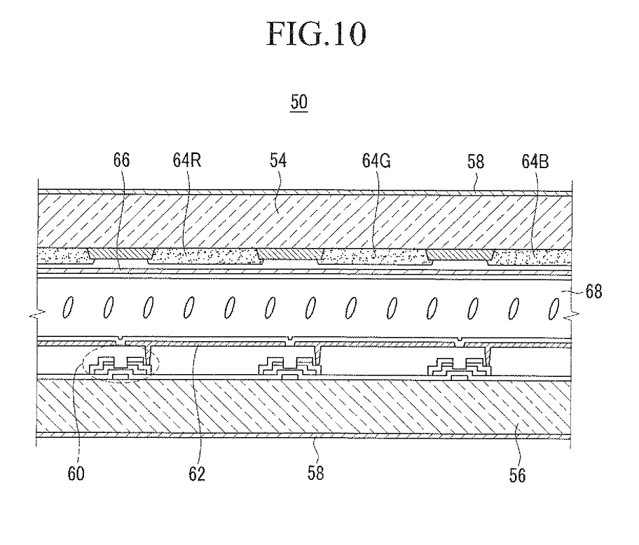

FIG. 10 is a partial sectional view of a display panel in the display device shown in FIG. 9.

Referring to FIG. 10, the display panel 50 includes upper and lower substrates 54 and 56, respectively, a pair of polarizing plates 58 attached to the outer surfaces of the upper and lower substrates 54 and 56, respectively, a plurality of thin film transistors 60 formed on the inner surface of the lower substrate 56, pixel electrodes 62 electrically connected to the thin film transistors 60, respectively, color filters 64R, 64G, and 64B formed on the inner surface of the upper substrate 54, a common electrode 66 covering the color filters 64R, 64G, and 64B, and a liquid crystal layer 68 sandwiched between the upper and lower substrates 54 and 56, respectively.

One thin film transistor 60 and one pixel electrode 62 are disposed at the respective sub-pixels of the display panel 50. The color filters 64R, 64G, and 64B include red, green, and blue color filters 64R, 64G, and 64B, respectively, corresponding to the pixel electrodes 62.

When the thin film transistor 60 at a specific sub-pixel turns on, an electric field is formed between the pixel and the common electrodes 62 and 66, and the alignment angle of the liquid crystal molecules varies due to the electric field so that the light transmittance is altered depending upon the variation of the alignment angle. The display panel 50 controls the luminance and color per the respective pixels through the above process so as to display a predetermined image.

Reference numeral 70 of FIG. 9 refers to a gate printed circuit board assembly (PBA) for transmitting gate driving signals to the gate electrode of the respective thin film transistors, and reference numeral 72 refers to a data printed circuit board assembly (PBA) for transmitting data driving signals to the source electrode of the respective thin film transistors.

The light emitting device 100 includes a smaller number of pixels than the display panel 50 such that one pixel of the light emitting device 100 corresponds to a plurality of pixels of the display panel 50. The pixels of the light emitting device 100 each correspond to the highest of the grayscales of the pixels of the display panel 50 corresponding thereto so as to emit light, and may express two to eight bits of grayscales.

For convenience, pixels of the display panel 50 are referred to as first pixels, pixels of the light emitting device 100 are referred to as second pixels, and first pixels corresponding to one of the second pixels are referred to as a first pixel group.

A process of driving a light emitting device 100 may include detecting the highest of the grayscales of the first pixels belonging to the first pixel group by way of a signal controller (not shown) for controlling the display panel 50, calculating the grayscales required for emitting light at the second pixel in accordance with the detected grayscales and converting the calculated into digital data, generating the driving signals of the light emitting device 100 by using the digital data, and applying the generated driving signals to the driving electrodes of the light emitting device 100.

The scan printed circuit board assembly and the data printed circuit board assembly for driving the light emitting device may be placed at the back side of the light emitting device. Reference numeral 74 of FIG. 9 refers to a first connector for connecting the cathode electrodes with the data printed circuit board assembly, and reference numeral 76 refers to a second connector for connecting the gate electrodes with the scan printed circuit board assembly. Reference numeral 78 refers to a third connector for applying anode voltages to the anode electrode.

As described above, the second pixel of the light emitting device emits light at a predetermined grayscale in synchronization with the first pixel group when an image is displayed at the first pixel group corresponding thereto. That is, the light emitting device 100 emits light with high luminance to the bright screen area displayed by the display panel 50, and light with low luminance to the dark screen area. Accordingly, with the display device 200 according to the present exemplary embodiment of the invention, the dynamic contrast ratio of the screen is increased so that the image quality can be enhanced in clearness.

Furthermore, with the light emitting device 100, the first to third regions A10 to A30 vary in luminance from the highest to the lowest in a sequence of the first region A10, the second region A20, and the third region A30. Accordingly, even if the light emitted from the first and second regions A10 and A20, respectively, is partially scattered and vanished to the outside while not being directed toward the display panel 50, the first and second regions A10 and A20, respectively, may give the same amount of light as the third region A30 to the display panel 50. Consequently, the edge of the display panel 50 is minimized in luminance reduction so that the luminance uniformity of the display screen can be enhanced.

While this disclosure has been described in connection with what is presently considered to be practical exemplary embodiments of the invention, it is to be understood that the invention is not limited to the disclosed embodiments, but, on the contrary, is intended to cover various modifications and equivalent arrangements included within the spirit and scope of the appended claims.

What is claimed is:

1. A light emitting device comprising cathode electrodes, gate electrodes insulated from the cathode electrodes by way of an insulating layer while proceeding in a direction crossing the cathode electrodes, electron emission regions formed on the cathode electrodes at crossed zones of the cathode electrodes with the gate electrodes, and a phosphor layer emitting visible light by way of the electrons emitted from the electron emission regions;
wherein the outermost cathode electrodes are each divided into at least two electrode portions including inner and outer cathode electrode portions and the outermost gate electrodes are each divided into at least two electrode portions including inner and outer gate electrode portions; and
wherein, when the region of the outer cathode electrode portion and the outer gate electrode portion is called a first region, the region of the inner cathode electrode portion and the inner gate electrode portion internal to the first region called a second region, and the region internal to the second region is called a third region, the first to third regions vary in electron emission intensity from the highest to the lowest in a sequence of the first region, the second region, and the third region.

2. The light emitting device of claim 1, wherein the cathode electrodes are formed with a same width and the gate electrodes are formed with a same width, and the outer cathode electrode portion and the Outer gate electrode portion are smaller in width than the inner cathode electrode portion and the inner gate electrode portion, respectively.

3. The light emitting device of claim 1, wherein the electron emission regions arranged at the first to third regions vary in density from a highest to a lowest in a sequence of the first region, the second region, and the third region.

4. The light emitting device of claim 3, wherein the electron emission regions have a same size over an entire area of the first to third regions.

5. A display device comprising the light emitting device of claim 1, and a display panel placed in front of the light emitting device to receive light from the light emitting device and display images.

6. The display device of claim 5, wherein the display panel has first pixels, and the light emitting device has second pixels which are smaller in number than the first pixels and which emit light corresponding to grayscales of the first pixels corresponding thereto.

7. The display device of claim 5, wherein the display panel comprises a liquid crystal display panel.

8. The light emitting device of claim 1, wherein the gate electrodes and the insulating layer have a plurality of openings for receiving the electron emission regions therein, and the insulating layer placed at the first to third regions varies in thickness from a smallest to a largest in a sequence of the first region, the second region, and the third region.

9. A display device comprising the light emitting device of claim 8, and a display panel placed in front of the light emitting device to receive light from the light emitting device and display images.

10. The display device of claim 9, wherein the display panel has first pixels, and the light emitting device has second pixels which are smaller in number than the first pixels and which emit light corresponding to grayscales of the first pixels corresponding thereto.

11. The display device of claim 9, wherein the display panel comprises a liquid crystal display panel.

12. The light emitting device of claim 8, wherein the electron emission regions have a same size and a same density over an entire area of the first to third regions, and the plurality of openings have a same size.

13. The light emitting device of claim 1, wherein an “on” pulse of gate voltage inputted into the outer gate electrode portion is larger in width than an “on” pulse of the gate voltage inputted into the inner gate electrode portion.

14. The light emitting device of claim 1, wherein a maximum “on” pulse level of gate voltage inputted into the outer gate electrode portion is greater than a maximum “on” pulse level of gate voltage inputted into the inner gate electrode portion.

15. The light emitting device of claim 1, wherein a minimum “on” pulse level of a gate voltage inputted into the outer gate electrode portion is smaller than a minimum “on” pulse level of a gate voltage inputted into the inner gate electrode portion.

16. The light emitting device of claim 1, wherein a pulse width of cathode voltage inputted into the outer cathode electrode portion during a period corresponding to an “on” pulse of gate voltage inputted into the outer gate electrode portion is smaller than a pulse width of a cathode voltage inputted into the inner cathode electrode portion during a period corresponding to an “on” pulse of gate voltage inputted into the inner gate electrode portion.

17. The light emitting device of claim 1, wherein a minimum pulse level of cathode voltage inputted into the outer cathode electrode portion during a period corresponding to an “on” pulse of gate voltage inputted into the outer gate electrode portion is smaller than a minimum pulse level of cathode voltage inputted into the inner cathode electrode portion during a period corresponding to an “on” pulse of gate voltage inputted into the inner gate electrode portion.

18. The light emitting device of claim 1, wherein a maximum pulse level of cathode voltage inputted into the outer cathode electrode portion during a period corresponding to an “on” pulse of gate voltage inputted into the outer gate electrode portion is greater than a maximum pulse level of cathode voltage inputted into the inner cathode electrode portion during a period corresponding to an “on” pulse of gate voltage inputted into the inner gate electrode portion.
